(19) United States
(12) Patent Application Publication
(10) Pub. No.: US 2020/0128994 A1
(43) Pub. Date: Apr. 30, 2020

(54) Christmas Tree Decorative Wrapping

(71) Applicant: Lloyd Ford, Houston, TX (US)

(72) Inventor: Lloyd Ford, Houston, TX (US)

(21) Appl. No.: 16/589,087

(22) Filed: Sep. 30, 2019

Related U.S. Application Data
(60) Provisional application No. 62/739,173, filed on Sep. 29, 2018.

(51) Int. Cl. A47G 33/08; F21S 4/10

(52) U.S. Cl. CPC A47G 33/08; F21W 2121/04; F21S 4/10

(57) ABSTRACT

An ornamental wrap for a Christmas tree that includes a mesh structure having non-breakable ornamental decorations permanently attached. The ornamental wrap includes lights that are attached along the horizontal plane along with ornamental bulbs and garland placed in an aesthetical pleasing positions.

THIS APPLICATION CLAIMS THE BENEFIT OF PROVISIONAL APPLICATION 62/739,173

### BACKGROUND OF THE INVENTION

This invention relates to ornament netting for Christmas trees. Decorations of Christmas trees typically the ornaments or ornament type decorations are hung, using a hook, individually on the tree branch, tree limb, or whatever the structure may have available for receiving the hook. After the ornaments are place on the tree they are then removed one at a time when the decorations are to be removed. Various apparatus are available to the decorator for hanging ornaments.

A Christmas tree is a decorated tree, usually an evergreen conifer such as spruce, pine, or fir or an artificial tree of similar appearance, associated with the celebration of Christmas. There is a wide variety of traditional ornaments, such as garlands, baubles, tinsel, and candy canes. An angel or star might be placed at the top of the tree to represent the Angel Gabriel or the Star of Bethlehem from the Nativity. Christmas ornaments are decorations usually made of glass, metal, wood, or ceramics that are used to decorate a Christmas tree.

Artificial trees became increasingly popular during the late 20^{th} century. Users of artificial trees asserts that they are more convenient, and because they are reusable, and much cheaper. They are also considered safer as natural trees can be a significant hazard.

The present invention provides an improved method of hanging/removal of ornaments on a Christmas tree.

### SUMMARY OF THE INVENTION

The decorative Christmas wrapping primary function is to provide an improved apparatus that is unitary and readily mountable on a more or less conical tree in a simple matter. Specifically, the netting solves the problem in references in use today, which is removing the ornaments from the Christmas tree one by one. As such the present invention will be described subsequently in greater detail.

Another object of the present invention is to provide an ornament net, which can be easily and efficiently manufactured and marketed. Main object of the present invention is to provide and ornament net that can easily mounted onto a Christmas tree.

Together with other objects of the invention, along with the various features of novelty which characterize the invention, are pointed out with particular in the claims annexed to and forming a part of this disclosure.

### BRIEF DESCRIPTION OF THE DRAWINGS

This invention is described by appended claims in relation to description of a preferred embodiment with reference to the following drawings which are described briefly as follows:

FIG. 1 illustrates a Christmas tree.

FIG. 2 depicts the present invention draped on a Christmas tree.

FIG. 3 illustrates Christmas tree with extensions.

FIG. 4 illustrates an exploded view of the Christmas tree connections.

### DETAILED DESCRIPTION OF THE INVENTION

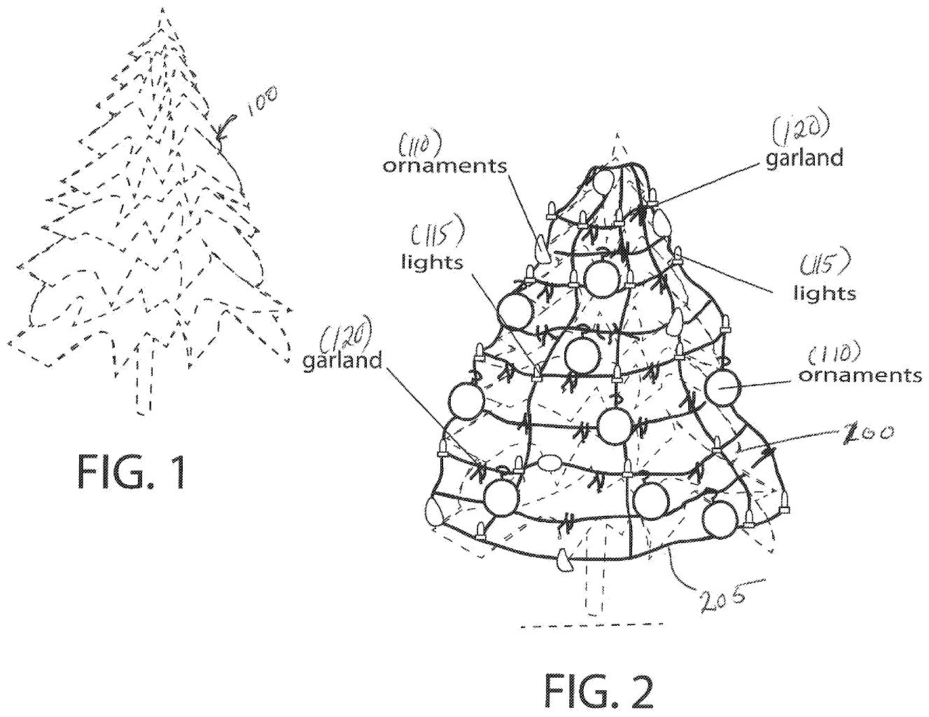

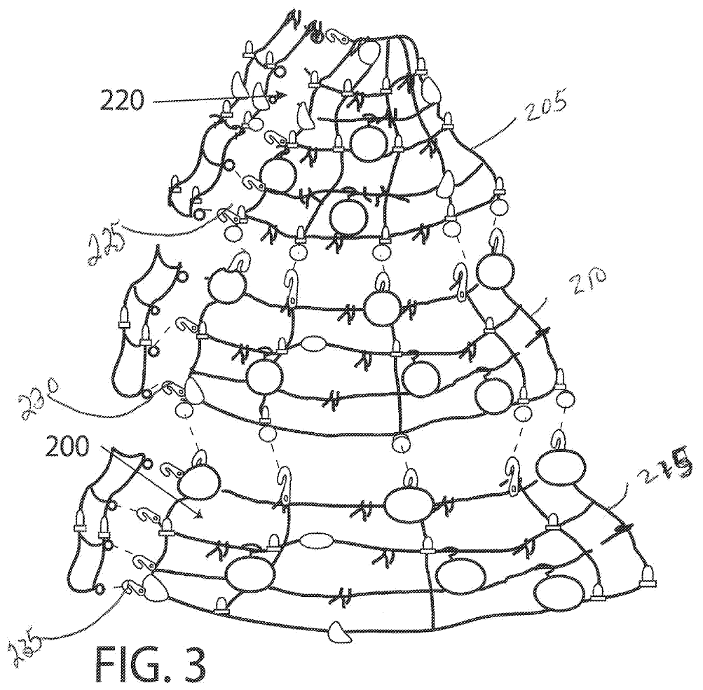

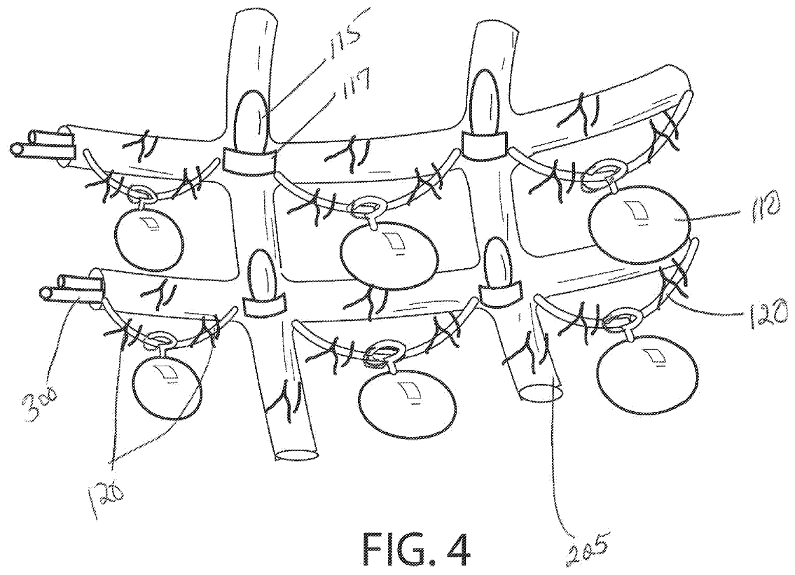

With reference now to the drawing in FIG. 1, an ornamental Christmas tree wrap embodying the principles and concepts of the present invention and generally designated by the reference numeral 10 will be described. The present invention, ornament wrap (10), is comprised of a web-like structure with ornamental elements permanently attached. Such components in their broadest context include web-like structure with lights, garland and ornaments permanently attached thereto.

As best illustrated in FIG. 1, the design of the article allows ornamental elements to be hung therefrom. The main component of the article is a web-like structure created by entwined material 16 that forms a mesh. In the embodiment illustrated, each mesh has substantially identical dimensions.

In alternative embodiments, each opening of the mesh does not have to be substantially the same, but can be various permutations that is required to support the limbs of the trees. However, each mesh needs to have an area of at least 2 inches by 2 inches to allow tree limbs to protrude therefrom. Each mesh can be polygonal, circular, oval or elliptical in shape. If each mesh is a square then it has four substantially equal sides.

The material used to make the ornamental netting may be cotton, synthetic fiber, plastic or flexible metal wire. In the preferred embodiment, the mesh structure is transparent, green, or white or any other masquerading color that allows it to merge in with the color of the tree. In the preferred embodiment the material is either a synthetic fiber or plastic.

The synthetic fibers can be selected from class of synthetic fibers know as polyamide, polyethylene, polypropylene, polyester, Lycra®, Nomex®, Kevlar®, Dacron®, Endura® Gold, or Decot. The fiber can also be an optical fiber. The use any one of these materials allows the manufacturer of the ornamental wrap forming the mesh of the netting with permanent connections. Additionally, the web like structure can be made of a composite material of a combination above. The permanently attached ornamental decorations will be made of a non-breakable material such as plastics, Styrofoam to allow for repetitive use.

In the present invention, in order for the wrap to support the lights an electrical conduction material has to permanently attached to the plane of the wrap and integrated into electrical wiring at a point of connection to a power source. The power source can be electrical, solar, or battery.

The material used to make the ornament netting may be cotton, synthetic fiber, plastic or flexible metal wire. In the preferred embodiment the material is either a synthetic fiber or synthetic fiber known as polyamide, polyethylene, polypropylene, and polyester.

In order for the ornamental wrap to function as designed it is important that it be drapable, over a Christmas tree as depicted in FIG. 1. The elongated line of the fiber of the mesh of the ornamental wrap runs horizontal and vertical. The ornaments and lights are permanently placed upon the horizontal plane of the ornamental wrap. The ornamental light sockets are generally permanently connected at the interconnecting points along the horizontal line of the mesh. Lights can be removably connected into the sockets. Additionally, the lights can be LED, normal electric bulbs, or another suitable lighting fixture. Garland is placed on the horizontal line below the ornamental lights, and ornamental bulbs are placed on the garland and between the lights. The permutation of the lights, garland, and bulbs can be customizable to support what is aesthetically pleasing to the eye. Alternatively, the lights can be placed upon the vertical plane.

Additionally, the mesh can be segmented into multiple sections to allow for an increase in tree size. The wrap is generally formed in a conical shape to fit the dimension of different trees. To increase the size of the wrap additional sheets can be attached along the bottom edge of the wrap. When two or more sheets are to be attached, additional ornamental wraps are coupled along the horizontal point of attachment. The advantage of this invention is that when the season is over, the wrap can be efficiently detached and removed.

What is claimed is:

1. An ornamental wrap for a Christmas tree comprising:
a web-like structure formed in a conical shape with disconnecting opposing sides;
The web-like structure further comprises a plurality of openings sufficient for the Christmas tree limbs to protrude therefrom;
The web-like structure having a horizontal plane and a vertical plane;
The horizontal plane further comprising electrical conductive wiring integrated therein;
at various interconnecting points along the horizontal plane is a light socket permanently attached thereto;
looping below the light sockets is garland that is permanently attached thereto;
and attached to the garland is non-breakable ornamental bulbs.
